(19) United States
(12) Patent Application Publication
(10) Pub. No.: US 2013/0169961 A1
(43) Pub. Date: Jul. 4, 2013

(54) SYSTEM FOR CLASSIFICATION OF MATERIALS USING LASER INDUCED BREAKDOWN SPECTROSCOPY

(71) Applicant: John Kraft, Newport (AU)

(72) Inventor: John Kraft, Newport (AU)

(73) Assignee: DATATRACE DNA PTY LIMITED, FRENCHS FOREST NSW (AU)

(21) Appl. No.: 13/638,579

(22) PCT Filed: Mar. 29, 2011
(86) PCT No.: PCT/AU2011/000360

§ 371 Date: Feb. 1, 2013

Related U.S. Application Data
(60) Provisional application No. 61/318,677, filed on Mar. 29, 2010.

(51) Int. Cl. G01N 21/63; E21C 41/00

(52) U.S. Cl. CPC G01N 21/63; E21C 41/00
USPC 356/318; 299/13

(57) ABSTRACT

A process for real-time classification of materials, the process including: conducting laser induced breakdown spectroscopy on the material (LIBS), wherein at least one second laser pulse is directed to the plume so as to selectively energize only a portion of the plume; measuring optical emissions from the energized portion of the plume; and assessing the elemental composition of the material on the basis of the optical emissions from the excited portion of the plume; wherein the energized portion of the plume is substantially smaller than the entire plume so that the measured optical emissions are relatively independent of the size of the entire plume and hence are relatively independent of the optical absorption and vaporization characteristics of the material, thereby allowing a more accurate assessment of the elemental composition of the material than if the assessment was based on the optical emissions from the entire plume.

### TECHNICAL FIELD

The present invention relates to a system and process for real-time classification of materials, and in particular to processes and systems for real-time classifications and/or spatial surveying of elemental, compound and stress fields, and other compositions in mining, prospecting, assaying, precision fanning, and a range of other human activities, using single or multiple-spark spectroscopy.

### BACKGROUND

The reference in this specification, to any prior publication (or information derived from it), or to any matter which is known, is not and should not be taken as an acknowledgment or admission or any form of suggestion that that prior publication (or information derived from it) or known matter forms part of the common general knowledge in the field of endeavour to which this specification relates.

A feature of numerous human activities involves discovering, mapping, and harnessing certain desired chemical elements or compounds in rock or soil. For example, the mining industry is built around the extraction and economic exploitation of mineral deposits that are enriched within certain geographic locations. Similarly, the farming industry relies on the presence of desired nutrients in the soil. Farming is focussed on areas where the soils contain these nutrients in relatively high concentrations. Industries such as prospecting and assaying are dedicated to discovering and mapping the geographic and spatial distributions of certain elements on or near to the Earth's surface.

To illustrate the economic importance of elemental and chemical mapping of this type, one may consider commercial mining operations, which need to distinguish between “ore”, which is defined as a mineral deposit that contains certain metals or minerals or compounds in economic concentrations, and “waste”, which is defined as rock and/or soil that does not contain economic concentrations of chemicals or minerals or metals. An efficient mining operation will excavate and process as much ore and as little waste as possible in order to maximize the profitability of the operation. In large scale milling operations, the difference of even a few percent in the proportion of waste to ore that is excavated and processed can have very significant commercial implications. Refining waste ties up productive plant and equipment in uneconomic activities. The difference between ore and waste can, however, be relatively small. Moreover, what is waste today can be ore tomorrow, since the term “ore” is defined by economics and markets, which are constantly changing. Furthermore, it can be desirable to blend different grades of ore or to blend one or more different grades of ore with waste in order to provide a product that is invariant over time and/or to provide a product that conforms to contractual supply obligations.

Geologists and chemists are usually the persons tasked with accurately delineating and mapping ore bodies, seams and zones of mineralization during mining operations. This mapping takes into account the 3-D distributions of the ore and waste within the rock “bench” adjoining the mining face. Chemists typically employ panoplies of analytical chemical techniques in this respect, including, inter alia, inductively-coupled plasma (ICP) and atomic absorption (AA) spectroscopy. However, such techniques are time-consuming and generally expensive. They also require extensive sample preparation, handling, and intensive treatment by skilled staff in fixed-site laboratories that may be far from the mining face. As such, it is usually only possible to analyze a limited number of samples, meaning that mine geologists and chemists are severely limited in their ability to accurately determine the boundaries between ore and waste, especially given the 3-D distributions of the elements of interest in the rock face. In some cases the ore and waste are characterized by specific minerals, known as “stress field” minerals, whose presence can simplify the identification of ore and waste. However, even in such cases it is generally difficult to accurately delineate ore from waste over large 2-D areas and 3-D volumes of material.

To illustrate these complexities, one may further consider that many mining operations excavate ore seams and deposits using explosives. That is, holes are drilled into or around the ore body and filled with explosives. When detonated, the explosives dislodge the ore and, possibly, some surrounding waste, producing so-called “rock-on-ground”, which is then typically collected and sent for milling and refining. Since the geological structure in the blast area is seldom uniform, such “rock-on-ground” can contain substantial variations in the quantities of desired elements. In effect, the dynamics of the explosive blast re-map the ore and waste distribution, greatly adding to the complexity of the situation in the field. Furthermore, the blast dynamics can themselves be, in part, a function of the ore and waste distributions in the rock adjoining the mining face. Due to the need to maintain production rates, there is usually insufficient time to properly assay the “rock-on-ground” and determine what is ore and what is waste. Moreover, the rock-on-ground is combined with rock-on-ground from other explosive excavations prior to processing. It is, generally, not possible to assay variations in the elemental compositions of the cumulative, collected “rock-in-transit” during, its transport to, and at, the refinery.

To properly distinguish ore from waste in mining is therefore not a simple matter. It ideally requires a sampling technique capable of collecting and analyzing elemental data in high frequency (real-time) at the mining face itself and at multiple points during transportation to the processing facility.

Several solutions to this problem have been proposed.

US 6753957, entitled “Mineral detection and content evaluation method”, teaches a method for essentially instantaneous analyses and comparison of two elements within an ore on a moving belt using an analytical technique known as laser-induced breakdown or spark spectroscopy, or LIBS. This technique employs a laser beam to generate, at the ore surface, a plume of energized material that produces atomic spectral emissions. The relative intensities of the emission lines, are characteristic of specific minerals or elements in the rock, with elevated contents of desirable elements being detectable. Using this approach, it is possible to differentiate a first substance (an ore) from a second substance (a waste) in real-time, allowing real-time sorting of the samples. WO 2006008155 describes a similar technique for performing chemical analyses of man-made surfaces in rock formations during mining or exploration activities. WO0014516 describes the use of a comparable technique in the identification of coal seams.

All of these techniques rely on a laser, closely proximate to the rock surface, directing single pulses of high energy radiation that produce spectral emissions at the rock surface. Despite constituting a substantial advance on traditional analytical techniques in mining, these forms of spectrometry nevertheless have significant disadvantages that can entirely negate their utility in mining operations. These disadvantages include the following:
(i) The techniques involve contact or near-contact with the rock face, meaning that the laser and light-collector element must be physically moved from one analysis point to the next on the rock face. This is time and energy consuming. In the challenging environment of a mine, it also risks physical damage to the apparatus, given the delicate nature of the components. This shortens the lifetime of the analytical device, which is typically expensive. The near contact nature of these methods furthermore complicates and hinders the measures required to resolve meaningful data for samples containing a substantial degree of inhomogeneity.
(ii) The quantities of each element present can only ever be approximately determined using these methods, since the size and character of the plume, as well as the intensity of the spectral lines that result, differ for each type of rock according to factors such as: (I) their hardness, (II) their ability to absorb the laser light and to produce a plume in a suitable manner when energized, and (III) the physical character of the plume, including the direction, and the amount of non-energized dust and particulate matter present, which can hinder and alter the light generated by the plume and the ability to successfully harvest that light for analysis. Because these factors can differ from place to place within the same rock sample, it is not generally viable to compare spectral data from one point on a rock sample with data from another point on the same sample, or from another sample, to thereby obtain sufficiently accurate elemental compositions.
(iii) These techniques are typically defeated by ambient dust and debris on the surface of rock faces. When energized, such ambient dust yields spectral data which is not representative of the elemental composition of the underlying rock. Alternatively, in non-energized form, it absorbs and blocks light generated in the technique, including both light from the laser and from the spectral emissions. The presence of ambient dust and particulate matter therefore skews the overall spectral data, making it unrepresentative of the actual elemental composition. The resulting data can be highly misleading, reducing the usefulness of these techniques and potentially exacerbating the inefficiencies of the extraction process at the mining face.

It is possibly for these and other reasons that, in spite of their potential utility, these techniques have not been widely taken up by the mining industry and appear to be generally limited in the patent literature to relatively uniform rock structures, such as those in coal seams or on moving belts after crushing.

WO 03006967, entitled “Method and Apparatus for Depth Profile Analysis by Laser. Induced Plasma Spectroscopy”, aims to address the problem of ambient dust and debris by using multiple laser pulses to first clear away surface debris, after which a later laser pulse is used to exclusively analyse the material at the bottom of a first ablation crater in the surface. This approach does not however, overcome the issues with hardness and other matters described in (ii) above, so that it still does not allow for the general detection of accurate elemental compositions.

It is desired, therefore, to provide a system and process for real-time classification of materials, a surveying process and system, and, a process for classifying a material into one of a plurality of predetermined categories, that alleviate one or more of the above difficulties, or at least provide a useful alternative.

### SUMMARY

In accordance with the present invention, there is provided a process for real-time classification of materials, the process including:
directing at least one first pulse of energetic photons from a laser to a surface of at least one material to vaporise a portion of the material and thereby form a plume of constituents of said material;
directing at least one second pulse of energetic photons from a laser to the plume to selectively excite only a portion of the plume;
measuring optical emissions from the excited portion of the plume; and
assessing the elemental composition of the material on the basis of the optical emissions from the excited portion of the plume;
wherein the excited portion of the plume is substantially smaller than the entire plume so that the measured optical emissions are relatively independent of the size of the entire plume and hence are relatively independent of the optical absorption and vaporisation characteristics of the material, thereby allowing a more accurate assessment of the elemental composition of the material than if the assessment was based on the optical emissions from the entire plume.

The process may include directing one or more laser beams near or into the plume to move the plume to a desired location. The one or more laser beams may have one or more wavelengths. The laser beams may be emitted from multiple lasers. The laser beams may emanate from multiple positions and/or directions. The laser beams may be may directed at multiple locations in or nearby the plume.

The process may include:
assessing the elemental compositions of one or more materials at a plurality of mutually spaced locations within a region;
generating location data representing spatial coordinates of said locations;
generating composition data representing the assessments of the materials; and
storing the location data in association with the composition data to represent the spatial distributions of elemental compositions of the materials in the region.

The spatial distributions may represent the spatial distributions of elemental compositions in three spatial dimensions.

The present invention also provides a system for real-time analysis of materials, the system including:
one or more lasers configured to generate pulses of photons of one or more wavelengths;
a spectrometer; and
an analyser;
wherein at least one of said lasers is configured to generate and direct at least one first pulse of energetic photons to a surface of a material to vaporise a portion of the material and thereby form a plume of constituents of said material;
at least one of said lasers is, configured to generate and direct at least one second pulse of energetic photons to the plume to selectively excite only a portion of the plume;
the spectrometer selectively measures optical emissions from the excited portion of the plume; and
the analyser assesses the elemental composition of the material on the basis of the optical emissions from the excited portion of the plume;
wherein the excited portion of the plume is substantially smaller than the entire plume so that the measured optical emissions are relatively independent of the size of the entire plume and hence are relatively independent of the optical absorption and vaporisation characteristics of the material, thereby allowing a more accurate assessment of the elemental composition of the material than if the assessment was based on the optical emissions from the entire plume.

The material may include a mineralogical material or a soil.

Embodiments of the present invention include improved processes and systems for accurate real-time analysis of elemental compositions, including:
the use of multiple-spark spectrochemistry to determine elemental compositions, where:
   (a) a first spark is used to create a plume on a surface,
   (b) one or more subsequent sparks are used to “steer” and/or “tailor” the plume in an advantageous fashion that may include: (i) moving it away from the surface, (ii) moving it so as to remove the presence of interfering, non-energized particulate matter and dust, or (iii) tailoring it for optimum light-harvesting from the emission. The steering or tailoring may be achieved, inter alia, by firing laser pulses into a region closely adjacent to the plume to move the plume towards or into that region.
   (c) one or more further subsequent sparks are used to re-energize a closely controlled portion of the resulting plume to thereby emit light having characteristic spectral lines from which elemental corn-positions can be accurately measured. Reilluminating or (re)energizing an existing plasma plume of material may involve one or more lasers of either the same wavelength or of a different wavelength or a combination of wavelength, pulses to obtain an accurate, reproducible determination of the elemental composition of the material since signal quality improves with the temperature of the plume and also because the subsequent laser pulse is used to energize a carefully controlled portion of the plume, not the whole of the plume. In this way it is generally possible to compensate for differences in, for example, the hardness and absorptivity of rock samples, which can otherwise lead to inaccurate quantization of the elements present.

The present invention also provides a surveying process, including:
(i) directing at least one first pulse of energetic photons from a laser to a surface of at least one material to vaporise a portion of the material and thereby form a plume of said material;
(ii) measuring optical emissions from the plume;
(iii) identifying constituents, of the vaporised material on the basis of the optical emissions from the plume;
(iv) generating, on the basis of the assessment, composition data representing the elemental composition of the plume;
(v) generating location data representing a spatial location of the plume;
(vi) storing the composition data in association with the location data; and
(vii) repeating steps (i) to (vi) for a plurality of plumes of one or more materials at respective mutually spaced locations to provide survey data representing a spatial survey of composition of the one or more materials.

Embodiments of the present invention also include a surveying process in which detailed maps of the elemental compositions within locations of interest are created using data from single- or multiple-spark spectrochemistry. The resulting maps then provide a means of optimizing the activity for which they are created.

Some embodiments employ a small, portable or a hand-held or a stand off laser and or spectrometer which may be air-cooled, fluid cooled and/or battery powered or powered via other suitable means.

In some embodiments, the small portable laser and spectrometer is attached to, or is part of a specialized machine used in the operation in question. For example, in some embodiments the spectrometer is a component of a boring machine used to bore holes for placing explosives during mining operations. In other embodiments, the spectrometer is a component of a tractor or machine-planter undertaking precision farming.

In some embodiments, data from the analysis is subjected to automated discriminant generation (i.e., “machine-learning”) techniques for data analysis, for example, the use of neural networks or equivalent statistical methods. The ability to program a “machine-learning” algorithm into the data analysis protocol employed is particularly advantageous in cases where there are substantial variations in the behaviour of spatially proximate samples under laser ablation, such as can occur in geological formations or agricultural soils.

In some embodiments, a spectrometer or equivalent imaging device directly captures the spectral emissions generated during the spectroscopic analysis, without the use of an intervening and possibly inefficient light collection system. Examples of spectrometers or imaging devices that can be used in such embodiments include:
(a) miniature spectrometers;
(b) solid state custom spectrometers tuned to specific emission lines;
(c) solid-state spectrometer devices coated with patterned filters to exclude all wavelengths other than those of interest. Such devices may involve an imaging chip, such as a Charge-Coupled Device (CCD) or similar chip, overlaid with a patterned filter in such a manner that each pixel on the chip is limited to receiving light which has been filtered to transmit only a particular wavelength of narrow range of wavelengths, and where the transmitted wavelength(s) differ from pixel to pixel; or
(d) Hyperspectral imaging devices, including modified digital cameras capable of measuring not only the presence and intensity of spectral lines of interest, but also their spatial position within the field of view. Such devices can, for example, be used to rapidly analyse ores and or waste where the ore and waste is inherently inhomogeneous. Such techniques can vastly increase the spatial sampling frequency of the method and/or the rate at which a very high spatial sampling frequency can be attained.

In some embodiments, the analyses performed using the laser and spectrometer are carried out at a distance from the target sample using a stand-off technique. The stand-off technique can be used to perform a raster-scan of a location of interest. The x, y, z information from such a raster scan can be used to create maps of structure and small and large scale homogeneity.

In some embodiments, the surveying process involves carrying out analyses at multiple different spatial positions within the location in such a way that each spatial position is computer logged and associated in the resulting data, to the elemental composition present at that position. In this way a detailed, high-resolution survey of the elemental composition of the location can be built up in real-time. Subsequently, this survey can be made readily accessible to a user of the computer software, allowing that user to make decisions in regard to, for example, ore vs. waste discrimination.

The precise location of each spatial position of each analysis can be automatically logged, without the need for human intervention, using GPS (Global Position Satellite technology), Differential GPS, triangulated radio- or other waves (e.g., using a IR Wii system), laser-positioning, or other automated positional techniques, to thereby create an accurate and an survey of the elemental composition of the location.

In some embodiments, the resulting survey is used to optimize the operation for which it is being created. For example, the survey map can be used to more efficiently collect and separate the ore from the waste in rock-on-ground or rock-in-transit during a mining operation. By way of another example, a survey map can be used to more accurately plant crops in precision farming operations. By way of a further example, the map may be used to determine the best position to place explosives for excavating earth during blasting in mining. This process, known as “draw-control”, refers to the optimization of the excavation of ore from seams of ore surrounded by waste materials.

In some embodiments, the resulting map is used to improve safety. For example, the map may be used to identify the presences of reactive pyrites minerals in mining bodies, thereby avoiding the possibility of premature detonation of excavating explosives that can be caused by these minerals.

In some embodiments, the resulting map is used to improve quality control. For example, the map may be used to optimize the blending of ores to thereby establish a more uniform grade of mineral in the ore to be processed during refining. Ore blending is a critical component of optimising the recovery and refinement of metals in many mining or manufacturing processes (e.g., the steel industry). In the same vein, the quality control data derived from the scanning process can be used in mine planning which depends on determinations about the strength and competency of rock in order to make assumptions about tunnel forms, column sizes, and other structural forms.

In some embodiments, the map is created in 3-dimensions. For example, in cases where multiple holes are bored into a rock bench adjoining a mining face prior to blasting, the elemental compositions of the bench can be measured multiple times at respective depths down each bore hole, to thereby build up a 3-D map of the elemental composition of the entire bench. In this way it is possible to optimize explosive excavation of the bench.

In some embodiments, the resulting 2-D or 3-D map is used as the basis for decision-making of the above or other types, in automated, robotic, or machine-directed applications including, but not limited to:
(a) prospecting, mining, agriculture, or similar applications;
(b) removal of “rock-on-ground” in a mining application;
(c) transportation to a refinery or an end-user in a mining application of “rock-in-transit”; and
(d) mining, farming, harvesting, or similar agricultural applications.

In order to create a more complete survey of the location of interest, the processes described herein can be combined with other analytical techniques, including but not limited to:
(a) laser-induced fluorescence,
(b) laser-induced Raman spectrometry to determine structure, including the organics present,
(c) the use of polarization information to determine crystal structure which is of significant value in determining the strength and competency of rock and which has other significant values in mining applications, and
(d) the use of hyperspectral imaging to capture raster or other scanning data and/or also as a means to measure inhomogeneity:

Some embodiments of the present invention provide a means of independently enhancing system capabilities, including:
(a) plume generation,
(b) plume conditioning, including plume steering by the same or different lasers,
(c) plume excitation by one or more lasers of one or more frequencies,
(d) plume excitation from multiple directions by one or more lasers of the same or different frequencies,
(e) as per the above but for stand off applications,
(f) as per (a-e) for applications involving polarized light,
(g) as per (a-f) above for applications involving Raman spectroscopy.

The present invention also provides a process for classifying a material into one of a plurality of predetermined categories, the process including applying a statistical classification method to measurements of optical emissions from the excited plumes of materials of respective known classifications to generate classification data for use in classifying other materials based on measurements of optical emissions from plumes of said other materials.

The present invention also provides a system for executing any one of the above processes.

### BRIEF DESCRIPTION OF THE DRAWINGS

Embodiments of the present invention are described hereinafter, by way of example only, with reference to the accompanying drawings in which:

FIG. 1 is an emission spectrum obtained using a double-pulse LIES technique in accordance with an embodiment of the present invention on a representative sample taken from one set of areas of a “rock-on-ground” sample created by blasting at Triton mine in Australia. The background shows a representative plot of the spectral emissions taken from a different area on the same sample;

FIG. 2 is a portion of an emission spectrum obtained using the double-pulse technique, on a representative sample of “ore” obtained from the Lake Cowal mine in Australia, showing the peak due to Gold (Au);

FIG. 3 is a portion of an emission spectrum obtained using the double-pulse technique, on a representative sample of “ore” obtained from the North Parkes mine in Australia, showing the peak due to Gold (Au);

FIG. 4 (upper) is an enlargement of a single emission line obtained using the double-pulse technique, on a representative sample taken from one set of areas of a “rock-on-ground” sample created by blasting at Lake Cowal mine in Australia; the lower graph shows a representative plot of the same line emission taken from a different area on the same sample;

FIGS. 5 and 6 depict how a rock bench adjoining the face of a mining operation may be surveyed in accordance with an embodiment of the present invention and then efficiently excavated by explosive detonation;

FIG. 7 shows in schematic form, a blending pad operation in which, according to one embodiment of the present invention, ores having different concentrations of a desired mineral are combined in such a way as to maintain absolute stability in the average concentration of the mineral in the materials which are fed into a refinery (thereby maximizing the efficiency with which the desired element is isolated);

FIG. 8 depicts a draw control process for mining a mineral seam in accordance with an embodiment of the present invention; and

FIG. 9 is a survey map of Hematite Zone Data as obtained using the laser spark spectroscopy technique described in the General Example (upper graph), and as obtained using standard wet chemistry techniques (lower graph).

### DETAILED DESCRIPTION

The described embodiments of the present invention include a process and system for real-time classification and surveying of compositions, and their use in, for example, maximizing the efficiency of mining, prospecting, precision farming, and a range of other human activities.

A process for real-time classification of materials includes:
directing at least one first pulse of energetic photons from a laser to a surface of at least one material to vaporise a portion of the material and thereby form a plume of constituents of said material;
directing at least one second pulse of energetic photons from a laser to the plume to selectively excite only a portion of the plume;
measuring optical emissions from the excited portion of the plume; and
assessing the elemental composition of the material on the basis of the optical emissions from the excited portion of the plume;
wherein, the excited portion of the plume is substantially smaller than the entire plume so that the measured optical emissions are relatively independent of the size of the entire plume and hence are relatively independent of the optical absorption and vaporisation characteristics of the material, thereby allowing amore accurate assessment of the elemental composition of the material than if the assessment was based on the optical emissions from the entire plume.

In some embodiments, the process includes directing one or more laser beams near or into the plume to move the plume to a desired location. The one or more laser beams can have one or more wavelengths. The laser beams may be emitted from multiple lasers. The laser beams may emanate from multiple positions and/or directions. The laser beams may be may directed at multiple locations in, or nearby the plume.

The process may include:
assessing the elemental compositions of one or more materials at a plurality of mutually spaced locations within a region;
generating location data representing spatial coordinates of said locations;
generating composition data representing the assessments of the materials; and
storing the location data in association with the composition data to represent the spatial distributions of elemental compositions of the materials in the region.

The spatial distributions may represent the spatial distributions of elemental compositions in three spatial dimensions.

A system for real-time classification of materials includes:
one or more lasers configured to generate pulses of photons of one or more wavelengths;
a spectrometer; and
an analyser;
wherein at least one of said lasers is configured to generate and direct at least one first pulse of energetic photons to a surface of a material to vaporise a portion of the material and thereby form a plume of constituents of said material;
at least one of said lasers is configured to generate and direct at least one second pulse of energetic photons to the plume to selectively excite only a portion of the plume;
the spectrometer selectively measures optical emissions from the excited portion of the plume; and
the analyser assesses the elemental composition of the material on the basis of the optical emissions from the excited portion of the plume;
wherein the excited portion of the plume is substantially smaller than the entire plume so that the measured optical emissions are relatively independent of the size of the entire plume and hence are relatively independent of the optical absorption and vaporisation characteristics of the material, thereby allowing a more accurate assessment of the elemental composition of the material than if the assessment was based on the optical emissions from the entire plume.

The material may include a mineralogical material or a soil.

The described embodiments of the present invention include improved processes and systems for accurate real-time analysis of elemental compositions, including:
the use of multiple-spark spectrochemistry to determine elemental compositions, where:
   (a) a first spark is used to create a plume on a surface,
   (b) one or more subsequent sparks are used to “steer” and/or “tailor” the plume in an advantageous fashion that may include: (i) moving it away from the surface, (ii) moving it so as to remove the presence of interfering, non-energized particulate matter and dust, or (iii) tailoring it for optimum light-harvesting from the emission. The steering or tailoring may be achieved, inter alia, by firing laser pulses into a region closely adjacent to the plume to move the plume towards or into that region,
   (c) one or more further subsequent sparks are used to re-energize a closely controlled portion of the resulting plume to thereby emit light having characteristic spectral lines from which elemental compositions can be accurately measured. Reilluminating or (re)energizing an existing plasma plume of material may involve one or more lasers of either the same wavelength or of a different wavelength or a combination of wavelength pulses to obtain an accurate, reproducible determination of the elemental composition of the material since signal quality improves with the temperature of the plume and also because the subsequent laser pulse is used to energize a carefully controlled portion of the plume, not the whole of the plume. In this way it is generally possible to compensate for differences in, for example, the hardness and absorptivity of rock samples, which can otherwise lead to inaccurate quantization of the elements present.

Also described herein is a surveying process, including:
(i) directing at least one first pulse of energetic photons from a laser to a surface of at least one material to vaporise a portion of the material and thereby form a plume of said material;
(ii) measuring optical emissions from the plume;
(iii) identifying constituents of the vaporised material on the basis of the optical emissions from the plume;
(iv) generating, on the basis of the assessment, composition data representing the elemental composition of the plume;
(v) generating location data representing a spatial location of the plume;
(vi) storing the composition data in association with the location data; and
(vii) repeating steps (i) to (vi) for a plurality of plumes of one or more materials at respective mutually spaced locations to provide survey data representing a spatial survey of composition of the on eor more materials.

Embodiments of the present invention also include a surveying process in which, detailed maps of the elemental compositions within locations of interest are created using data from single- or multiple-spark spectrochemistry. The resulting maps then provide a means of Optimizing the activity for which they are created.

Some embodiments employ a small, portable or a hand-held or a stand off laser and or spectrometer which may be air-cooled, fluid cooled and/or battery powered or powered via other suitable means.

In some embodiments, the small portable laser and spectrometer is attached to, or is part of a specialized machine used in the operation in question. For example, in some embodiments the spectrometer is a component of a boring machine used to bore holes for placing explosives during mining operations. In other embodiments, the spectrometer is a component of a tractor or machine-planter undertaking precision farming.

In some embodiments, data from the analysis is subjected to automated discriminant generation (i.e., “machine-learning”) techniques for data analysis, for example, the use of neural networks or equivalent statistical methods. The ability to program a “machine-learning” algorithm into the data analysis protocol employed is particularly advantageous in cases where there are substantial variations in the behaviour of spatially proximate samples under laser ablation, such as can occur in geological formations or agricultural soils.

In some embodiments, a spectrometer or equivalent imaging device directly captures the spectral emissions generated during the spectroscopic analysis, without the use of an intervening and possibly inefficient light collection system. Examples of spectrometers or imaging devices that can be used in such embodiments include:
(a) miniature spectrometers;
(b) solid state custom spectrometers tuned to specific emission lines;
(c) solid-state spectrometer devices coated with patterned filters to exclude all wavelengths other than those of interest. Such devices may involve an imaging chip, such as a Charge-Coupled Device (CCD) or similar chip, overlaid with a patterned filter in such a manner that each pixel on the chip is limited, to receiving light which has been filtered to transmit only a particular wavelength or narrow range of wavelengths, and where the transmitted wavelength(s) differ from pixel to pixel; or
(d) Hyperspectral imaging devices, including modified digital cameras capable of measuring not only the presence and intensity of spectral lines of interest, but also their spatial position within the field of view. Such devices can, for example, be used to rapidly analyse ores and or waste where the ore and waste is inherently inhomogeneous. Such techniques can vastly increase the spatial sampling frequency of the method and/or the rate at which a very high spatial sampling frequency can be attained.

In some embodiments, the analyses performed using the laser and spectrometer are carried out at a distance from the target sample using a stand-off technique. The stand-off technique can be used to perform a raster-scan of a location of interest. The x, y, z information from such a raster scan can be used to create maps of structure and small and large scale homogeneity.

In some embodiments, the surveying process involves carrying out analyses at multiple different spatial positions within the location in such a way that each spatial position is computer logged and associated in the resulting data, to the elemental composition present at that position. In this way a detailed, high-resolution survey of the elemental composition of the location can be built up in real-time. Subsequently, this survey can be made readily accessible to a user of the computer software, allowing that user to make decisions in regard to, for example, ore. vs. waste discrimination.

The precise location of each spatial position of each analysis can be automatically logged, without the need for human intervention, using GPS (Global Position Satellite technology), Differential GPS, triangulated radio- or other waves (e.g., using a IR Wii system), laser-positioning, or other automated positional techniques, to thereby create an accurate and an absolute survey of the elemental composition of the location.

In some embodiments, the resulting survey is used to optimize the operation for which it is being created. For example, the survey map can be used to more efficiently collect and separate the ore from the waste in rock-on-ground or rock-in-transit during a mining operation. By way of another example, a survey map can be used to more accurately plant crops in precision farming operations. By way of a further example, the map may be used to determine the best position to place explosives for excavating earth during blasting in mining. This process, known as “draw-control”, refers to the optimization of the excavation of ore from seams of ore surrounded by waste materials.

In some embodiments, the resulting map is used to improve, safety. For example, the map may be used to identify the presences of reactive pyrites minerals in mining bodies, thereby avoiding the possibility of premature detonation of excavating explosives that can be caused by these minerals.

In some embodiments, the resulting map is used to improve quality control. For example, the map may be used to optimize the blending of ores to thereby establish a more uniform grade of mineral in the ore to be processed during refining. Ore blending is a critical component of optimising the recovery and refinement of metals in many mining or manufacturing processes (e.g., the steel industry). In the same vein, the quality control data derived from the scanning process can be used in mine planning which depends on determinations about the strength and competency of rock in order to make assumptions about tunnel forms, column sizes, and other structural forms.

In some embodiments, the map is created in 3-dimensions. For example, in cases where multiple holes are bored into a rock bench adjoining a mining face prior to blasting, the elemental compositions of the bench can be measured multiple times at respective depths down each bore hole, to thereby build up a 3-D map of the elemental composition of entire bench. In this way it is possible to optimize explosive excavation of the bench.

In some embodiments, the resulting 2-D or 3-D map is used as the basis for decision-making of the above or other types, in automated, robotic, or machine-directed applications including, but not limited to:
(a) prospecting, mining, agriculture, or similar applications;
(b): removal of “rock-on-ground” in a mining application;
(c) transportation to a refinery or an end-user in a mining application of “rock-in-transit”; and
(d) mining, farming, harvesting, or similar agricultural applications.

In order to create a more complete survey of the location of interest, the processes described herein can be combined with other analytical techniques, including but not limited to:
(a) laser-induced fluorescence,
(b) laser-induced Raman spectrometry to determine structure, including the organics present,
(c) the use of polarization information to determine crystal structure which is of significant value in determining the strength and competency of rock and which has other significant values in mining applications, and
(d) the use of hyperspectral imaging to capture raster or other scanning data and/or also as a means to measure inhomogeneity.

Some embodiments include a means of independently enhancing system capabilities, including:
(a) plume generation,
(b) plume conditioning, including plume steering by the same or different lasers,
(c) plume excitation by one or more lasers of one or more frequencies,
(d) plume excitation from multiple directions by one or more lasers of the same or different frequencies,
(e) as per the above but for stand off applications,
(f) as per (a-e) for applications involving polarized light,
(g) as per (a-f) above for applications involving Raman spectroscopy.

Some embodiments include, a process for classifying a material into one of a plurality of predetermined categories, the process including applying a statistical classification method to measurements of optical emissions from the excited plumes of materials of respective known classifications to generate classification data for use in classifying other materials based on measurements of optical emissions from plumes of said other materials.

### EXAMPLES

In the examples below, the following experimental setup was used. Geological samples were irradiated with photons generated by Big Sky 200 mJ CFR Q-switching Nd:YAG pulsed lasers. Elemental emissions were collected by an optical fibre assembly including multiple 600 μM UV-VIS patch cords, each with a collimating focusing lens built into the fiber termination. Each fibre was routed into a high-resolution optical spectrometer, providing spectral analysis with an optical resolution of ˜0.1 nm, in the wavelength range 200-580 nm. Geological samples were analyzed in a custom-built sample chamber and subjected to laser irradiation protocols involving single or multiple laser firings. Each laser pulse was typically 15.47 J/pulse, with a time separation of 180 μs and no refocusing between pulses.

### GENERAL EXAMPLE

### Standard Methods of Classification Digital Sampling During Surveying as a Method of Real-Time Classification

Conventional approaches to laser spark spectroscopy seek to classify a material by one of two methods. These approaches are:
Qualitative: indicating qualitatively the presence of an element by confirming the presence of a particular emission line. While qualitatively useful, this approach does not offer quantitative information in mining applications because many ore bodies involve concentration gradients. Thus, spark spectroscopic analysis of both ore and waste would typically indicate the presence of a particular target element but give indication of whether the material being examined is an ore or a waste. Nor will this approach offer an indication of the type or grade of ore present.
B. Quantitative: Quantitatively measuring the chemical composition of pertinent elements down to low concentrations (ppm or lower). This approach typically requires significant chemical and/or mechanical pre-processing to make the sample suitable for analysis. For example, the sample would typically have to be mechanically homogenised and then pressed into disks or pellets in order to normalize the possible variables present. Each different variation in the target material would then also be expressed accurately in a calibration curve in order to output a reasonably accurate measurement of the concentration of the target element. Any change in the composition or the concentration of other elements requires an entire new family of calibration curves. Applying such processes may, nevertheless, yield accurate quantitative information regarding the make-up of the ore or waste and thereby assist in ore-waste discrimination or ore-grade determination.

The above methods have utility in ore-waste discrimination or ore-grade determination in mining applications, but are not suitable for real-time analysis. This is because:
a. Rocks are, in the main, innately heterogeneous materials composed of a plethora of minerals. The spark spectroscopic method however, samples a single pinpoint on the mineral and therefore gives a highly localized analysis.
b. The minerals have a variety of habits and sizes. Some present as glasses.
c. The minerals themselves are solid state systems, composed of elements that undergo rampant elemental substitution.
d. The materials are generally quite rough.
e. The materials exhibit a variety of hardness, so an element present in one mineral, and crystal can report more strongly than the same element in another mineral and crystal.
f. Elements have innately different responses under laser spark spectroscopy.
g. Geometric surface effects such as but not limited to
   a. variations in focus of the laser
   b. variations in angle of incidence of the laser beam.

Even when the concentration of a specific element is known, the classification of ore, ore grade and waste may well be influenced by the presence of:
h. Pernicious minerals that affect smelting etc
i. Specific combination of minerals that affect mine processing
j. Gross rock characteristics that are not expressed in elemental percentages but that can affect the ease and hence cost of extraction of ore.

This general example describes a new method of directly creating an ore-waste discriminant and/or of creating an ore-grade discriminant based on whole spectra or subsets of whole spectra without:
1. Physical or chemical preprocessing of the sample, such as physically homogenizing the sample,
2. Any need for calibration curves to determine the percentage of single elements present in a specific type of material, or
3. Needing to generate and more specifically, program a classification system from a list of specific material concentrations.

The method involves collecting spectra in such a manner that they can be used to indicate the ore and or waste in question. The technique involves physically tracking the laser over geological or mining samples whilst constantly firing the laser in multi-shot pulse trains. The individual spectra thus obtained, are then stacked into a single spectrum. The data is thereby homogenized digitally at the time of collection. That is, variations in homogeneity, mineral habits, and the like, are averaged out. This is achieved without the need for extensive sample preparation. The resulting, homogenized spectra can be used to reliably indicate whether the sample is an ore or a waste. This is typically achieved by comparing the homogenized single spectrum to a homogenized reference spectrum of an ore or a waste and mathematically correlating the similarities or differences using a standard correlation algorithm. There is no need to laboriously construct calibration curves.

A typical example of the method is as follows:

A mining or geological sample is physically traversed while being subjected to a 50-shot laser pulse train. The pattern of the shots may be in a 1-D direction, or a raster pattern. This form of data collection could include sampling materials that are wholly or partially composed of powder. That is, the technique may have the effect of moving and changing the sample and the sampling may in fact occur in a powder cloud formed by the shockwave created by one of the earlier shots. Any of the above can be combined with multiple shots at a single location to sample below the surface. This method also cancels noise in the data collection, especially noise associated with variable focus depths and variable angles of incidence.

The resulting spectra are then stacked (averaged) into a single, homogenized spectrum. The whole of this spectrum, or portions thereof (but including a plurality of spectral lines), are then used to classify the ore, ore-grade or waste material, using a statistical method that does not require any particular spectral lines to be identified, but just treats the spectrum (or part thereof) as information characteristic of the sample. This ‘information’ is then provided to a statistical classification method to determine which of a plurality of known categories is the most likely category for the sample, based on similar information determined for other samples known to belong to those same categories. The statistical classification method can include:
i. Correlation to one or more ore and or one or more waste models created, by the user or system. For example, a reference homogenized spectrum of an ore can be used. Mathematical correlations with a goodness-of-fit >0.9 can then indicate that the sample is an ore with a high level of reliability. Correlations of <0.9 indicate a waste. The cut-off point for this decision is typically determined empirically. This could be done using:
ii. Machine learning systems that Wild classification systems from a learning set. That is, one measures and stores the homogenized spectra of a set of samples of ores and/or wastes and/or ore grades, that have previously been classified as ore or waste, or, classified by ore grade, using compositions determined by wet chemistry. The spectra correlation parameters for ore-waste and or for ore grade are then established by machine learning algorithms operating over this known training set. In this way, a rapid and relatively reliable indication of ore and waste discrimination, or of ore-grade can be obtained.

It is to be understood that the current invention extends to the use of this digital sampling method, as well as the Qualitative and Quantitative methods already known to the art and described in A and B above. The remaining examples may employ any of these methods.

### Example 1

### Precision Separation of Rock-on-Ground into Ore and Waste

A “rock-on-ground” sample at the Triton mine in Australia was analysed at multiple different spatial locations using double-pulse spectroscopy, where two pulses are fired from, the same laser. In general, two different types of spectra were obtained, depending on precisely where sampling was performed on the rock pile.

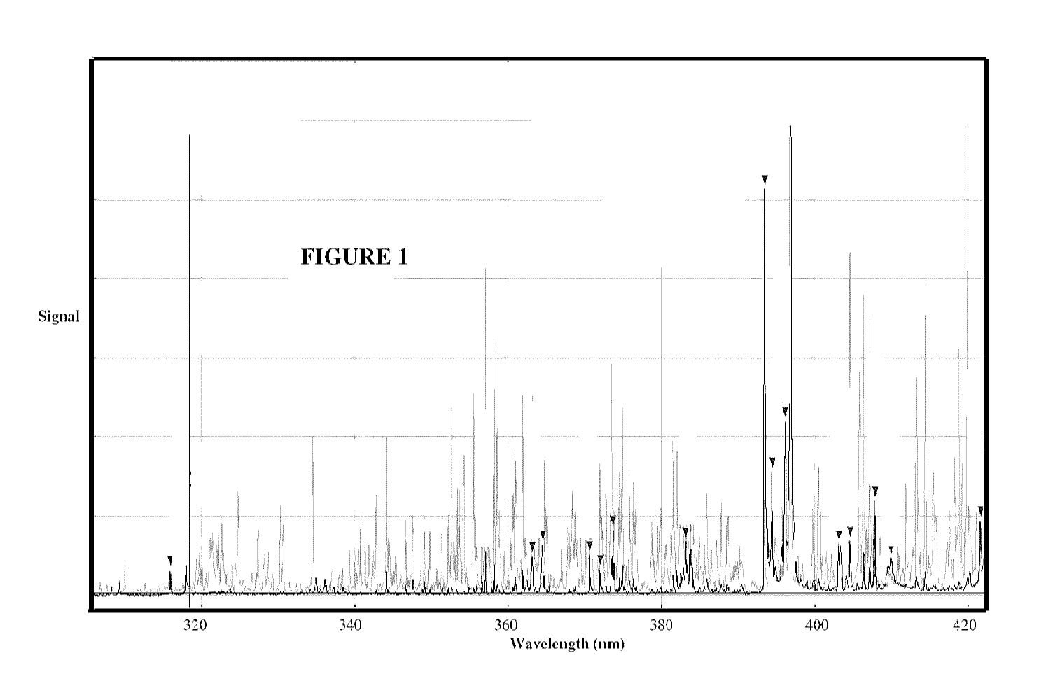

FIG. 1 shows representative optical emission spectra obtained (a) exclusively at one periphery of the rock pile (dark black lines) and (b) at, essentially, all other points examined on the rock pile (“background spectrum”, light grey line).

As can be seen, the spectrum of the latter area (background) contains more peaks and higher peaks than the spectrum of the former area (the foreground). Each peak corresponds to a particular element (mostly metals in this case), some of which have been, labelled in the Figure. The height of each peak is representative of the quantity of the corresponding element in the corresponding sampled portion of the rock pile.

Thus, by the qualitative analysis technique described above in A, it is immediately apparent, even from a cursory examination of the two spectra shown in FIG. 1, that the latter area which was examined (background spectrum) is virtually exclusively “ore”. The former area that was examined (foreground spectrum) contains, by contrast, mainly “waste” material.

Using one of the other techniques described above, it is possible to rapidly and reliably develop a detailed, accurate survey of the ore and waste components of the exposed surface layer of rock-on-ground and to immediately identify which portions of the surface layer of the rock pile should be processed and which should be left unprocessed. This can be done in real-time using the method described in the General Example above. After removing that surface layer, the analysis is repeated, providing a survey of the new surface layer and indicating again which portions should be collected for processing. This procedure is repeated continuously until the rock pile has been unambiguously and scientifically separated into ore and waste.

### Example 2

### Precision Surveying and Mining Selected Mineral Compositions in Real-Time

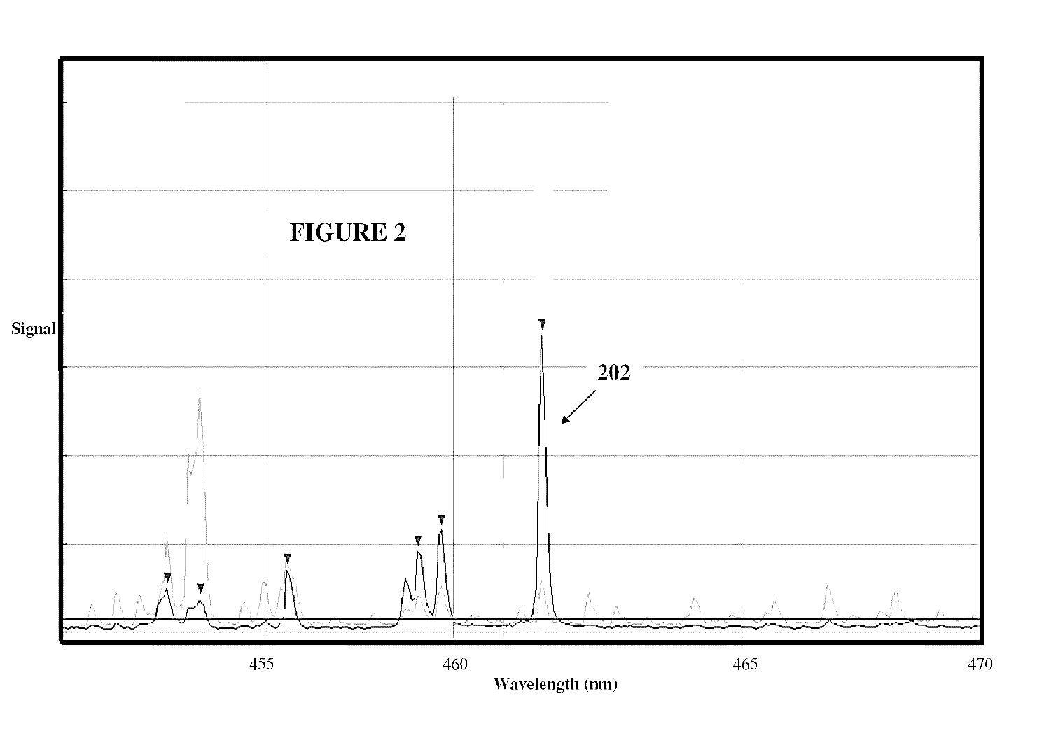

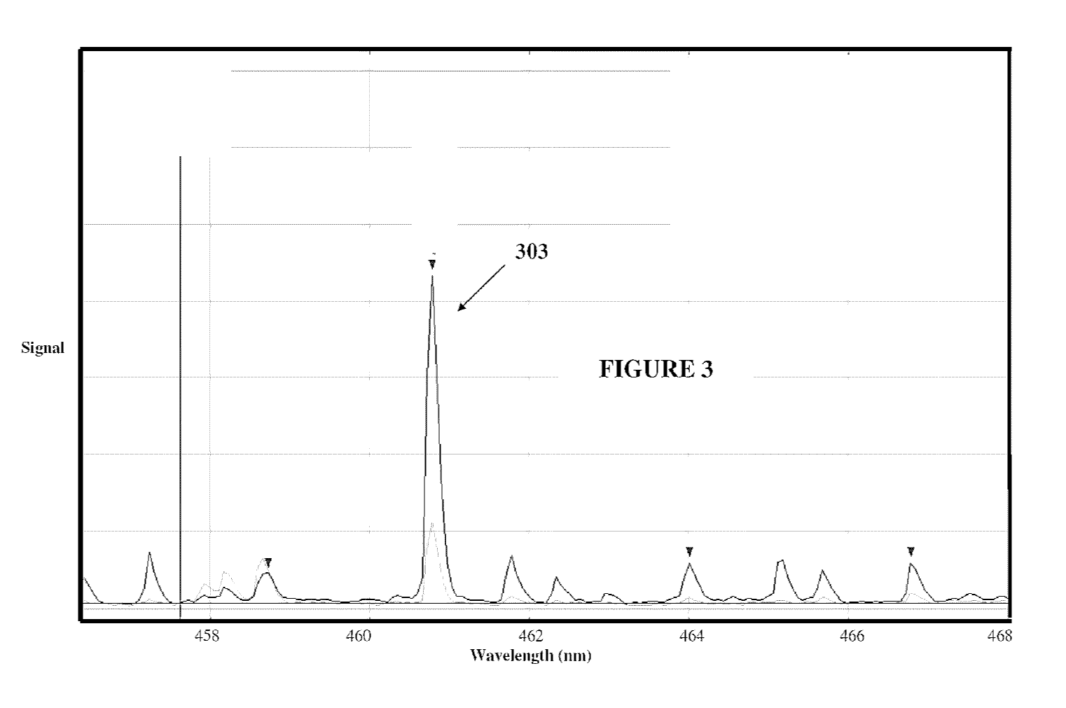

To illustrate the power of the processes and systems described herein, FIGS. 2 and 3 depict representative double-pulse optical emission spectra collected from “ores” at the Lake Coal and North Parkes mines in Australia. For clarity, the displayed portions of the spectra in FIGS. 2 and 3 have been limited to prominently show the gold (Au) spectral emission 202, 302 at ˜461 nm. The spectrum can be analysed using the techniques described above to qualitatively or quantitatively determine the amount (ppm) of gold in the rock at each point that an analysis is performed. Using the method described in the General Example above, each analysis takes a fraction of a second. This is potentially extremely valuable information to gold mines, since by analysing different spatial locations they can map in high precision where the gold is and how much of it there is This can be done in real time during excavation. The refining process can then be tuned to appropriately process the ore grade that is being refined at that time.

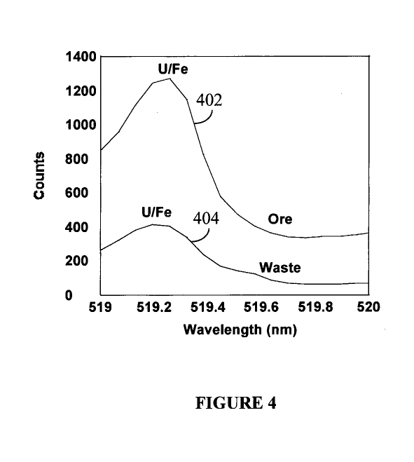

FIG. 4 shows a single spectral line for an “ore” 402 and a “waste.” 404 sample from the Lake Cowal mine. The spectral line corresponds to uranium (U) and/or Iron (Fe). It is possible to qualitatively or quantitatively analyze rock samples for other elements, and to do this in a highly specific and definite way using one or more of the techniques described above. Thus, using such a process, one is able to determine surveys of multiple elements, including, for example, elements that can be isolated simultaneously with the metal of interest, or elements that may interfere with the isolation of the element of interest during the refining process to be applied. Mining can then selectively excavate ores having very particular constitutions and leave ores of other, more difficult constitutions for another time.

### Example 3

### Precision Surveying of the Rock Bench Adjacent to a Mining Face for Excavation with Explosives; Assuring Safety During Packing of Explosives

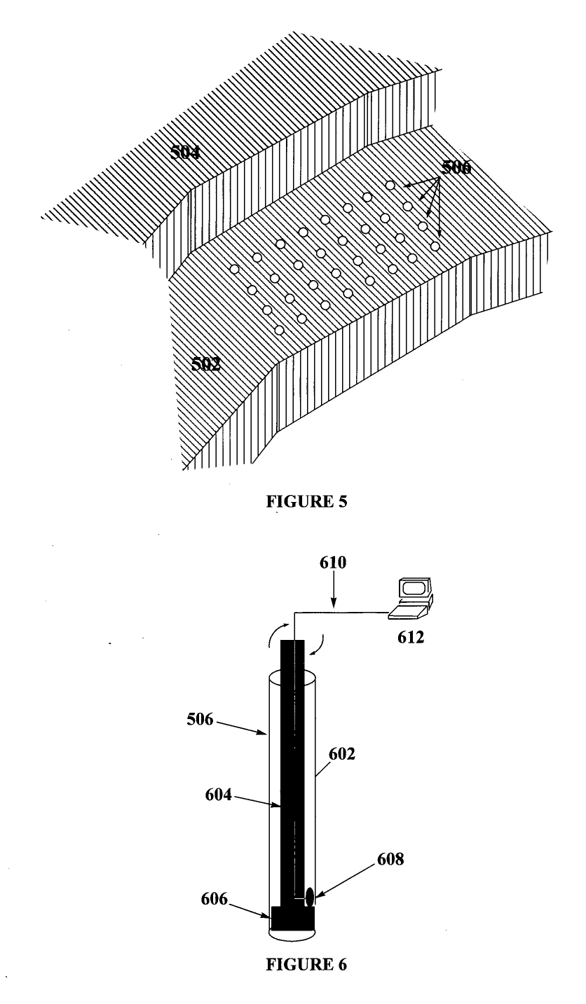

FIG. 5 schematically depicts a portion of an open cut mining operation having “benches” on several levels, including the levels shown as 502 and 504. To mine a portion of the lower bench on level 502, four lines of boreholes 506 have been drilled into the rock bench. Each of these boreholes 506 is filled with explosives which, when detonated, excavates that part of the level 502. The drilling of one 602 of the holes 506 is illustrated in FIG. 6. During the drilling of the hole 602, a drill with shaft 604 and drillhead 606 is used to make the hole 602. In this particular drill, a spectrometer 608 is positioned immediately behind the drillhead 606. The spectrometer 608 is connected, via a cable 610, to a computer 612 which logs the spectra of the rock as a function of the depth of the borehole 602 during drilling. In this way, and applying the technique in the General Example, or one of the other techniques, the computer 612 builds up a survey of the different strata in the rock bench 502 down the length of the borehole 602. When the data for all of the boreholes 506 are combined, the computer 612 generates a 3-D survey of the elemental composition of the rock bench 502. The computer 612 is configured to automatically analyse the data as it arrives from the spectrometer 608. In the event that the computer 612 recognizes a possible hazard, such as a pyrites deposit at any point in the rock bench, it sends an alert to the blasting crew, who are then forewarned to avoid this particular deposit. Moreover, having a detailed and accurate survey of the rock bench 502 in hand, the computer 612 is in a position to classify the ore and waste present and advise the best way to excavate the bench 502 using standard methods known to the mining industry. This may involve, for example, varying the quantity of explosive charges in each hole for maximum efficiency in excavating the ore.

### Example 4

### Precision Surveying of Ores During a Blending Pad Operation; Precision Quality Control of Blended Materials

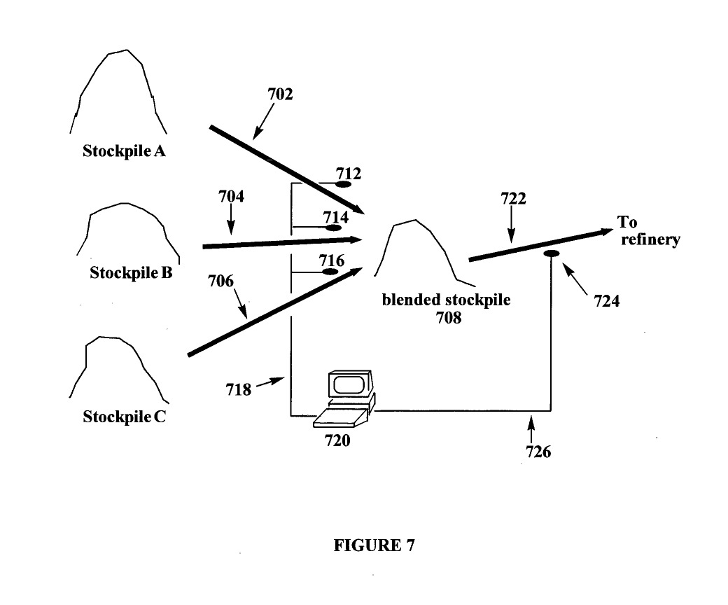

FIG. 7 depicts, in schematic form, a blending pad operation. A mine has three different operations, each yielding ores of different element composition. The three operations deposit their ores in respective stockpiles A, B, or C. A conveyor belt 702 carries ore from stockpile A to a central “blending” stockpile 708. Conveyor belt 706 carries ore from stockpile B to the blended stockpile 708. Conveyor belt 706 carries ore from stockpile C to the blended stockpile 708. The composition of the ores on each of these conveyors 702, 704, 706 is monitored by having three optical spectrometers 710, 712, 714. Spectrometer 712 monitors conveyor belt 702. Spectrometer 714 monitors conveyor belt 704. Spectrometer 716 monitors conveyor belt 706. Each spectrometer 712, 714, 716 is connected via cables 718 to a central computer 720. Using the real-time data from the spectrometers 712, 714, 716, the computer 720 controls the rate of addition from each of conveyor 702, 704, 706 to ensure that the blended stockpile 708 contains as close as possible to a desired fixed composition that is preferred for refining. Conveyor 722 carries the blended material 708 to the refinery. A central spectrometer 724, which is connected to the computer 720 via a cable 726, monitors and performs quality control on the blended ore sent to the refinery.

### Example 5

### Precision Optimisation of Draw Control During Mining of a Mineral Seam

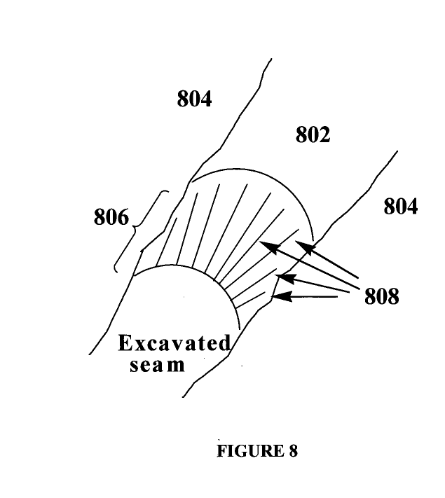

FIG. 8 illustrates a seam 802 of a mineral running through a non-mineral region 804. To mine the seam 802, it is necessary to excavate it in stages, taking and processing as little as possible of the surrounding waste 804. The next stage to be excavated in this particular case is shown by 806. A series a long holes 808 have been bored into the face of the seam. Explosives will be placed into these holes and detonated. It is important to excavate only the seam 802; that is, the seam 802 must be drawn out of the surrounding rock 804. To this end, a profile of the ore grade or ore-waste as a function of the depth of each hole has been collected and the make-up of the excavation area 806 has been mapped in detail and in 3-D. Explosives may then be placed in accordance with this map and in such a way as to maximize the efficiency of the excavation. Using this approach, better draw control is achieved.

### Example 6

### Generating Accurate Maps for Mining Using Digital Sampling

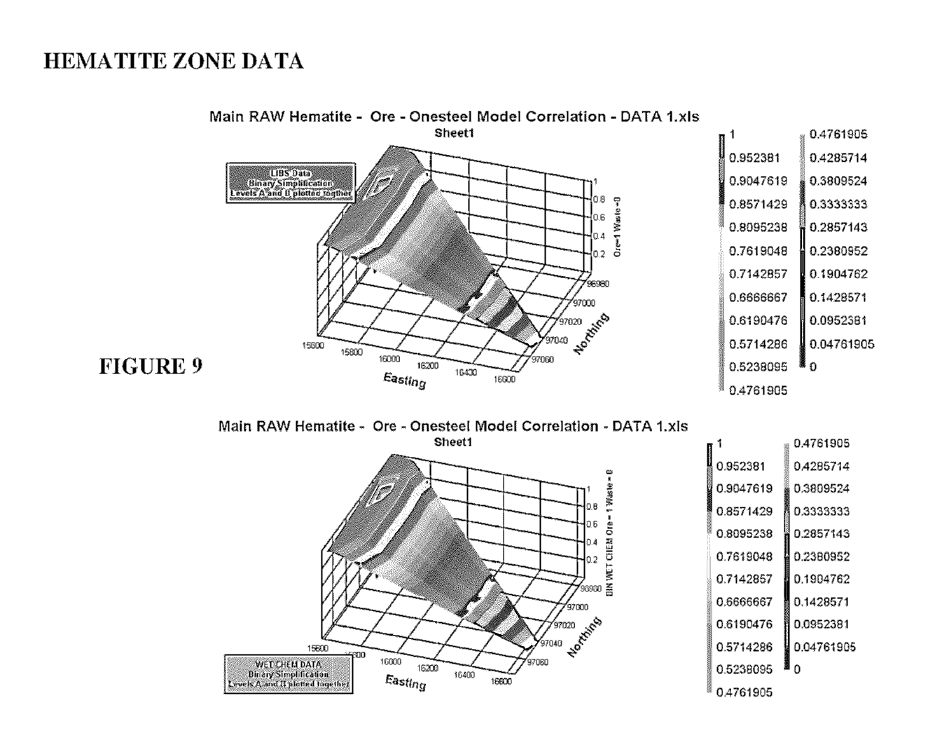

Highly accurate maps of ore and waste or ore-grade can be rapidly generated using the above technique and in the above applications without need for laborious processes. FIG. 9 (top) indicates, a map of raw hematite in a mining area using the method described in the General Example. FIG. 9 (bottom) indicates a comparable map obtained using laborious wet chemical analysis techniques. As can be seen, the two maps are essentially identical.

Many modifications will be apparent to those skilled in the art without departing from the scope of the present invention.

1. A process for real-time classification of materials, the process comprising:
directing at least one first pulse of energetic photons from a laser to a surface of at least one material to vaporize a portion of the material and thereby form a plume of constituents of said material;
directing at least one second pulse of energetic photons from a laser to the plume to selectively excite only a portion of the plume;
measuring optical emissions from the excited portion of the plume; and
assessing the elemental composition of the material on the basis of the optical emissions from the excited portion of the plume;
wherein the excited portion of the plume is substantially smaller than the entire plume so that the measured optical emissions are relatively independent of the size of the entire plume and hence are relatively independent of the optical absorption and vaporization characteristics of the material, thereby allowing a more accurate assessment of the elemental composition of the material than if the assessment was based on the optical emissions from the entire plume.

2. The process of claim 1, comprising directing one or more pulses of energetic photons from a laser into or near the plume to move the plume to a desired location.

3. The process of claim 2, wherein the energetic photons have a plurality of wavelengths.

4. The process of claim 2, wherein the pulses of energetic photons are directed to the plume from a plurality of positions and/or directions.

5. The process of claim 2, wherein the pulses of energetic photons are directed at multiple locations in or near the plume.

6. The process of claim 2, wherein said assessing comprises:
assessing the elemental composition of the at least one material at a plurality of mutually spaced locations within a region of interest;
generating location data representing spatial coordinates of said locations;
generating composition data representing the results of the assessments of the at least one material; and
storing the location data in association with the composition data to represent at least one spatial distribution of elemental composition of the at least one material in the region of interest.

7. The process of claim 6, wherein the at least one spatial distribution comprises three spatial dimensions.

8. A process for classifying a material into one of a plurality of predetermined categories, the process comprising applying a statistical classification method to measurements of optical emissions from the excited plumes of materials of respective known classifications to generate classification data for use in classifying other materials based on measurements and assessment of optical emissions from plumes of said other materials.

9. A surveying process, comprising:
(i) directing at least one first pulse of energetic photons from a laser to a surface of at least one material to vaporize a portion of the material and thereby form a plume of said material;
(ii) measuring optical emissions from the plume;
(iii) identifying constituents of the vaporized material on the basis of assessment of the optical emissions from the plume;
(iv) generating, on the basis of the assessment, composition data representing the elemental composition of the plume;
(v) generating location data representing a spatial location of the plume;
(vi) storing the composition data in association with the location data; and
(vii) repeating steps (i) to (vi) for a plurality of plumes of one or more materials at respective mutually spaced locations to provide survey data representing a spatial survey of elemental composition of the at least one material.

10. The process of any one of claims 1, 8 or 9, wherein the assessments of elemental composition are performed using the laser and spectrometer at a distance from the target sample using a stand-off technique.

11. The process of any one of claims 1, 8 or 9, wherein the energetic photons from the laser are scanned over a region of interest and the spatial coordinates used to scan the photons are used to generate a corresponding spatial map of composition.

12. The process of any one of claims 1, 8 or 9, comprising using a survey or map of the elemental composition to improve the collection and separation of ore from waste in rock-on-ground or rock-in-transit during a mining operation.

13. The process of any one of claims 1, 8 or 9, comprising using a survey or map of the elemental composition to determine locations to place explosives for excavating earth during blasting in mining.

14. The process of any one of claims 1, 8 or 9, comprising using a survey or map of the elemental composition to identify the presence of reactive pyrites minerals in mining bodies.

15. The process of any one of claims 1, 8 or 9, comprising using surveys or maps of elemental composition of a plurality of ores of respective elemental compositions to control the blending the ores.

16. The process of any one of claims 1, 8 or 9, comprising:
forming bore holes in a rock bench adjoining a mining face prior to blasting;
determining elemental compositions at respective depths down each bore hole;
generating a 3-D map of elemental composition of the entire bench based on the locations of the bore holes and the determined elemental compositions; and
determining explosive excavation of the bench based on the 3-D map.

17. The process of any one of claims 1, 8 or 9, comprising using surveys or maps of elemental composition as the basis for decision-making in automated, robotic, or machine-directed applications comprising:
(a) prospecting, mining, agriculture, or similar applications;
(b) removal of “rock-on-ground” in a mining application;
(c) transportation to a refinery or an end-user in a mining application of “rock-in-transit”; and
(d) mining, farming, harvesting, or similar agricultural applications.

18. The method or system of any one of claims 1, 8 or 9, wherein the material comprises a mineralogical material or a soil.

19. A system for real-time classification of materials and configured to execute any one of claims 1, 8 or 9.

20. A system for real-time classification of materials, the system comprising:
one or more lasers configured to generate pulses of photons of one or more wavelengths;
a spectrometer; and
an analyzer;
wherein:
at least one of said lasers is configured to generate and direct at least one first pulse of energetic photons to a surface of a material to vaporize a portion of the material and thereby form a plume of constituents of said material;
at least one of said lasers is configured to generate and direct at least one second pulse of energetic photons to the plume to selectively excite only a portion of the plume;
the spectrometer selectively measures optical emissions from the excited portion of the plume; and
the analyzer assesses the elemental composition of the material on the basis of the optical emissions from the excited portion of the plume; and
wherein the excited portion of the plume is substantially smaller than the entire plume so that the measured optical emissions are relatively independent of the size of the entire plume and hence are relatively independent of the optical absorption and vaporization characteristics of the material, thereby allowing a more accurate assessment of the elemental composition of the material than if the assessment was based on the optical emissions from the entire plume.

21. The system of claim 20, wherein the lasers and spectrometer are attached to, or are components of a boring machine, a tractor, or a machine-planter undertaking precision farming.

22. The system of claim 20, wherein the spectrometer directly captures the spectral emissions from the plume without the use of an intervening light collection system.
